(19) United States
(12) Patent Application Publication
(10) Pub. No.: US 2006/0224653 A1
(43) Pub. Date: Oct. 5, 2006

(54) Method and system for dynamic session control of digital signal processing operations

(76) Inventors: Kimming So, Palo Alto, CA (US); Jason Leonard, San Jose, CA (US); Philip J. Houghton, Surrey (CA); Henry Li, Vancouver (CA); Baobinh N. Truong, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 11/212,949

(22) Filed: Aug. 25, 2005

Related U.S. Application Data
(60) Provisional application No. 60/667,481, filed on Apr. 1, 2005.

(51) Int. Cl. G06F 7/38

(52) U.S. Cl. 708/490

(57) ABSTRACT

A method and system for performing digital signal processing operations in a computer system are disclosed. In addition to the ability to perform DSP operation on a new hardware platform, this method and system allow the dynamic and global control of saturation and left shifting prior to accumulation.

### RELATED APPLICATIONS

This application claims priority to and claims benefit from: U.S. Provisional Patent Application Ser. No. 60/667,481, entitled “METHOD FOR DYNAMIC SESSION CONTROL OF DIGITAL SIGNAL PROCESSING OPERATIONS” and filed on Apr. 1, 2005.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Digital Signal Processing (DSP) is the processing of a stream of information by digital means. A common DSP application is the filtering of signals to improve signal quality or to extract important information. For example, an analog signal can be digitized using a device, such as an analog-to-digital converter, to generate an output in the form of binary numbers that represent the analog signal. As an alternative to using analog electronics, DSP techniques can process the digitized analog signal.

Although the mathematical theory underlying DSP techniques such as digital filter design and signal compression can be complex, the numerical operations required to implement these techniques comprise multiplication, addition, subtraction, and binary shifting. The ability to perform DSP techniques on multiple hardware platforms in an efficient manner is important for various applications.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

The present invention discloses a method and system for dynamic session control while performing digital signal processing operations in a computer system. Digital Signal Processing (DSP) operations such as multiply and add (MADD) or multiply and subtract (MSUB) can be performed by general-purpose microprocessors. The DSP operations are directed to n-bit operands that are in m-bit registers. The register size (m) may be a multiple of the operand size (n). For example, the DSP operations may utilize 32-bit registers with 16-bit or 8-bit operands, or the DSP operations may utilize 64-bit registers with 32-bit, 16-bit, or 8-bit operands.

The location of a binary signal value in a larger microprocessor register is appended to the instructions. The instructions define the location of the operand with the register eliminating the need for addition shift operations.

The multiplication may require the enabling of saturation. The product may be shifted prior to accumulation or subtraction. When multiple DSP operations require the identical selection of shifting and saturation, it is advantageous to dynamically enable or disable these features.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is an illustration of an exemplary architecture for dynamic session control of DSP operations in accordance with the present invention;

FIG. 2 is an illustration of an exemplary set of operations that may be utilized for dynamic session control of DSP operations in accordance with the present invention; and

FIG. 3 is a flowchart illustrating an exemplary method for dynamic session control of DSP operations in accordance with the present invention.

### DETAILED DESCRIPTION OF THE INVENTION

Aspects of the present invention relate to digital signal processing (DSP) operations. Although the following description may refer to particular 16-bit operations, other operations requiring multiplication and accumulation may be performed without departing from the spirit and scope of the present invention.

DSP instructions such as MADD (Multiply and Add) or MSUB (Multiply and Subtract) may comprise a shift left one position of the multiplication result. These instructions may also comprise an allowance for saturation of the multiplication results. The shift left and the saturation may be mutually exclusive.

A global saturate and shift left (GSSL) field in a control register can indicate the saturation mode and the shift left to be performed by all associated DSP instructions. For example, GSSL can take 4 values:
1) GSSL=0: NO Saturation allowed and NO Shift Left
2) GSSL=1: NO Saturation allowed and Shift Left
3) GSSL=2: Saturation allowed and NO Shift Left
4) GSSL=3: Saturation allowed and Shift Left

After the GSSL is set to a certain value, all the DSP instructions use the same attributes. If the DSP needs to operate in a different way, the GSSL can be changed. Using a dynamic field eliminates the need for introducing separate instructions for each mode. A session of computations may require one attribute, and another session of computations may require a different attribute. If the computations are identical in all other respects, only the field must change and no additional code is required.

In a computer system in which each execution element can execute DSP instructions independently, each execution element should have its own copy of a GSSL field for independent control by different DSP programs running on individual execution element.

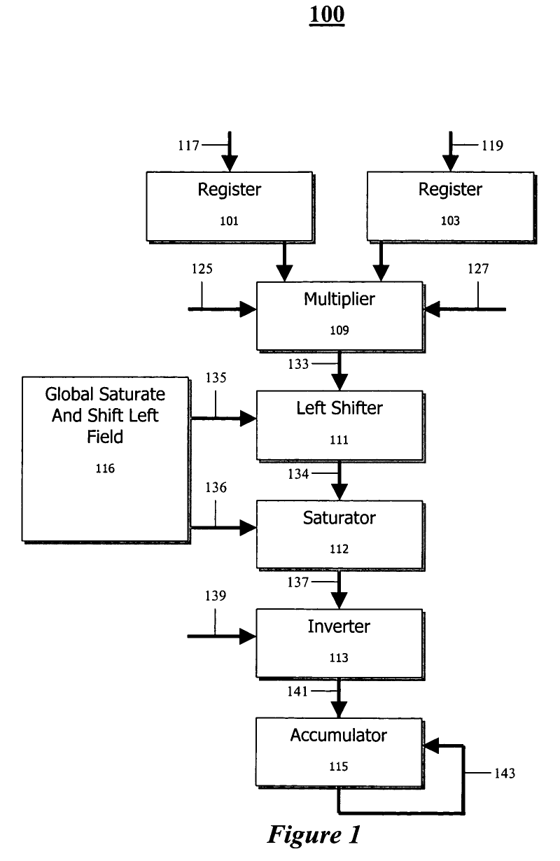

FIG. 1 is an illustration of an exemplary architecture 100 in which a representative embodiment of the present invention may be practiced. The architecture 100 may comprise registers 101 and 103, a multiplier 109, a left shifter 111, a saturator 112, an inverter 113, an accumulator 115, and a global saturate and shift left field 116.

The first register 101 will receive a first operand 117. The second register 103 will receive a second operand 119. The bit width of the registers 101 and 103 may be larger than the bit width of the operands 117 and 119. For example, the registers 101 and 103 may by 32 bits wide and the operands 117 and 119 may be 16 bits wide. If the operands 117 and 119 are 16 bits wide and the registers are 32 bits wide, the 16-bit operands 117 and 119 need to be placed in 32-bit registers 101 and 103 before the DSP operation can begin.

The operands 117 and 119 in the registers 101 and 103 are multiplied in the multiplier 109 to produce a product 133. The ased on a first shift register control bit at 125. The control signal at 125 can identify the location of the first operand 117 in the first register 101, and the control signal at 127 can identify the location of the second operand 119 in the second register 103. For example, a 16-bit wide operand may occupy an upper portion or a lower portion of a 32-bit wide first register.

The global saturate and shift left (GSSL) field 116 can indicate whether saturation is allowed 136 and whether a shift left is to be performed with a shift control bit at 135. A left shift of one position can be performed on the product 133 based on the shift control bit 135. If saturation is allowed 136, the left shifter output 134 can be saturated to 0×7fffffff if the product 133 is 0×40000000.

The inverter 113 can negate the saturator output 137 based on a subtraction bit 139. The inverter output 141 is sent to the accumulator 115 where it can be added to the content 143 of the accumulator 115. If overflow or underflow occurs when adding the shifted multiplication result to the content 143 of the accumulator 115, then the result can be saturated to the maximum or minimum signed integer value. For a 32-bit accumulator register 0×7ffffffff is the saturation value for a positive overflow and 0×80000000 is the saturation value for a negative overflow (underflow). A flag may be set to indicate overflow or underflow.

A set of instructions can be added to a control processor of a system to provide Digital Signal Processing (DSP) computational capability. The control processor can be a 32-bit processor, wherein each general purpose register is 32-bit wide, and the operands of the DSP computations can be 16-bit wide or less.

For example, a DSP operation could be ‘multiply and add’ (MADD) and have a format:
MADD rs, rt, n

The operation performs a multiplication of the contents of the general purpose registers rs and rt, adds the multiplication result to the accumulator, and saves the final result in the n-th accumlator. Similarly, a DSP operation could be ‘multiply and subtract’ (MSUB) and have a format:
MSUB rs, rt, n

An instruction set can also be extended to indicate that a GSSL field is to be associated with each instruction. An instruction set can be extended further to indicate the location an operand may occupy in a register of larger bit width. For example, a DSP operation could be ‘multiply operands, add the product to the accumulator, check the GSSL, the first operand is in a high position, and the second operand is in a low position’ and have a format:
MADDX.hl rs, rt, n

If the registers are at least twice as larger as the operands, the instruction set can be extended to allow dual operations. For example, a first register (R1) and a second register (R2) may comprise a high portion and a low portion. The two multiplications can be:

| | MULT 1 | MULT 2 |
|---|---|---|
| Dual (d) | R1/high * R2/high | R1/low*R2/low |
| Dual Cross (dx) | R1/low *R2/high | R1/high*R2/low |

The resulting products are both added to or subtracted from the accumulator.

The instructions can correspond to op-codes comprising bits that indicate control signals 125, 127, 135, and 139 as described in reference to FIG. 1. There may be elements of logic between actual bits of an op-code and the control of options in FIG. 1.

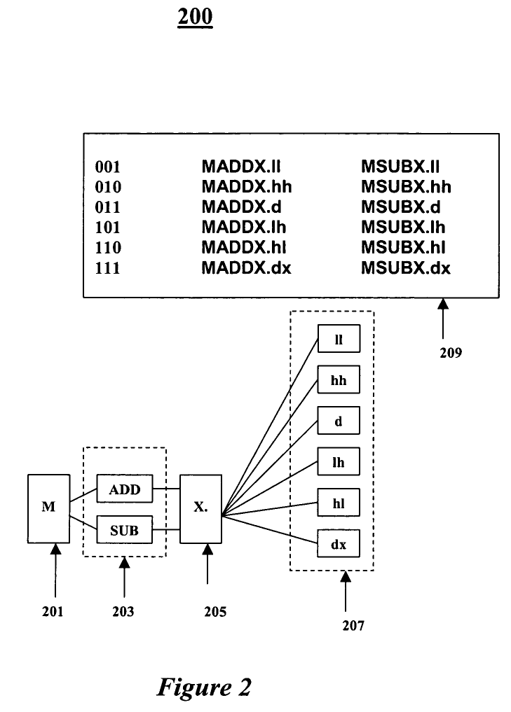

An exemplary set 200 of instructions that can be performed in a computer system are shown in FIG. 2. An example of semantics for the instructions 209 may:
M for ‘Multiply’ 201;
‘ADD’ or ‘SUBtract’ 203;
‘X’ to indicate a GSSL field is required 205; and
an extension 207 can be one of:
   ‘11’ for R1/low * R2/low;
   ‘hh’ for R1/high * R2/high;
   ‘d’ for R1/high * R2/high+R1/high * R2/high;
   ‘1h’ for R1/low * R2/high;
   ‘h1’ for R1/high * R2/low; and
   ‘dx’ for R1/high * R2/low+R1/low * R2/high.

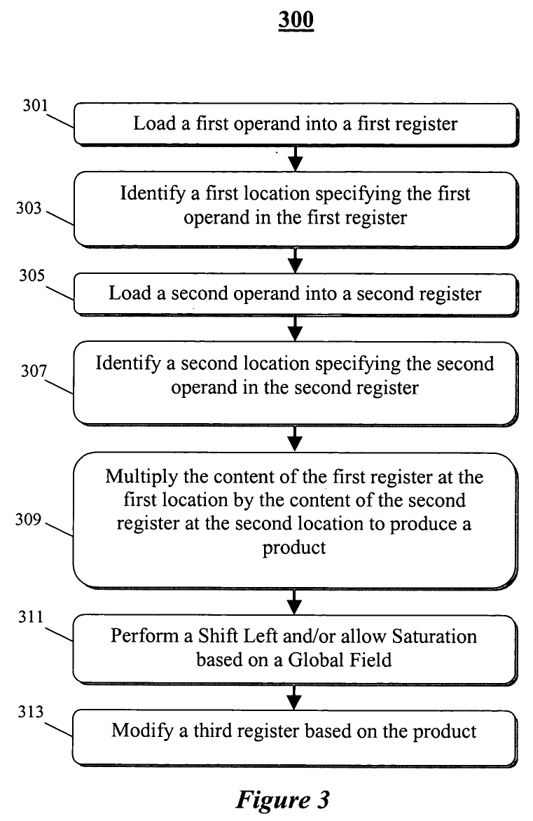

FIG. 3 shows a flowchart illustrating an exemplary method performing a 16-bit operation in a 32-bit system, in accordance with a representative embodiment of the present invention.

A first operand is loaded into a first register at 301. The location of the first operand is identified at 303. For example, a 16-bit operand can occupy either the upper portion or the lower portion of the first register.

A second operand is loaded into a second register at 305. The location of the first operand is identified at 307.

The content of the first operand, located in the first register, is multiplied by the content of the second operand, located in the second register, to produce a product at 309. A shift left is performed and/or saturation is allowed based on a Global Field at 311. To account for the format of the operands, a left shift may be included. For example, the multiplication of two signed binary numbers may result in a product with two sign bits, and the shift left will result in the appropriate single sign bit. Depending on the application, that exceeds the size of (i.e. saturates) a register may or may not need to be set to a maximum value.

A third register is modified based on the product at 313. The third register can be an accumulator, and the modification to the accumulator can be and addition of subtraction of the product.

Although the above description refers to examples using 16-bit DSP operations and 32-bit computer system registers, the present invention is not limited to the particular aspects described. Variations of the examples provided above may be applied to a variety of DSP operations without departing from the spirit and scope of the present invention.

Accordingly, the present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for dynamic session control of a digital signal processing operation, wherein the method comprises:
loading a first operand into a first location of a first register;
loading a second operand into a second location of a second register;
multiplying the first register by the second register to produce a product; and
modifying the product based on a global field.

2. The method of claim 1, wherein the first operand comprises 16 bits, the first register comprises 32 bits, and the first location is an upper portion of the first register.

3. The method of claim 1, wherein the first operand comprises 16 bits, the first register comprises 32 bits, and the first location is a lower portion of the first register.

4. The method of claim 1, wherein the second operand comprises 16 bits, the second register comprises 32 bits, and the second location is an upper portion of the second register.

5. The method of claim 1, wherein the second operand comprises 16 bits, the second register comprises 32 bits, and the second location is a lower portion of the second register.

6. The method of claim 1, wherein the method further comprises:
modifying a third register with the product.

7. The method of claim 6, wherein the modifying is adding.

8. The method of claim 6, wherein the modifying is subtracting.

9. The method of claim 1, wherein modifying the product based on a global field comprises shifting the product.

10. The method of claim 1, wherein modifying the product based on a global field comprises allowing saturation.

11. A system for performing a digital signal processing operation:
a first register for storing a first operand, wherein the first operand occupies a first location in the first register;
a second register for storing a second operand, wherein the second operand occupies a second location in the second register;
a multiplier for multiplying the first register by the second register to produce a product; and
a left shifter for selectively shifting the product based on a global field.

12. The system of claim 11, wherein the first operand comprises 16 bits, the first register comprises 32 bits, and the first location is an upper portion of the first register.

13. The system of claim 11, wherein the first operand comprises 16 bits, the first register comprises 32 bits, and the first location is a lower portion of the first register.

14. The system of claim 11, wherein the second operand comprises 16 bits, the second register comprises 32 bits, and the second location is an upper portion of the second register.

15. The system of claim 11, wherein the second operand comprises 16 bits, the second register comprises 32 bits, and the second location is a lower portion of the second register.

16. The system of claim 11, wherein the system further comprises:
a saturator for selectively allowing saturation based on a global field.

17. The system of claim 11, wherein the system further comprises:
an inverter for selectively inverting the product.

18. The system of claim 11, wherein the system further comprises:
an accumulator for adding a third register to the product.
